(19) United States
(12) Patent Application Publication
(10) Pub. No.: US 2015/0286401 A1
(43) Pub. Date: Oct. 8, 2015

(54) PHOTO/VIDEO TIMELINE DISPLAY

(71) Applicant: LYVE MINDS, INC., Cupertino, CA (US)

(72) Inventors: Jeff Ma, Cupertino, CA (US); Justin Lee, Cupertino, CA (US); Edgar Lee, Cupertino, CA (US); Scott Zimmerman, Cupertino, CA (US); Phillip Anthony Myles, Cupertino, CA (US)

(21) Appl. No.: 14/680,715

(22) Filed: Apr. 7, 2015

Related U.S. Application Data
(60) Provisional application No. 61/976,888, filed on Apr. 8, 2014.

(51) Int. Cl. G06F 3/0488; G06F 3/0484

(52) U.S. Cl. CPC G06F 3/04883; G06F 3/04847; G06F 3/04845

(57) ABSTRACT

Embodiments of the invention include a method for displaying stacks of photos in a timeline on a user display. The timeline and/or position of the stacks of photos may be translated in time and/or the granularity of the time may be changed in response to a gesture from a user received through a user interface such as, for example, a touchscreen.

### FIELD

This disclosure relates generally to a timeline display for photo and/or videos.

### BACKGROUND

With the advent of digital photography and smartphones people are collecting more and more photos (and videos). These photos can have large file sizes and may be difficult to sort through, find relevant photos, and/or index. Moreover, the large number of photos being collected makes collection, sorting, indexing, and displaying of photos challenging.

### SUMMARY

Embodiments of the invention include a method for displaying stacks of photos in a timeline. The timeline and/or position of the stacks of photos may be translated in time and/or the granularity of the time may be changed in response to a gesture from a user received through, for example, a touchscreen.

Some embodiments include a method including displaying a plurality of stacks of photos on a touchscreen of a user device with respect to a timeline; receiving a first touch gesture through the touchscreen; in response to receiving the first touch gesture, changing the granularity of the timeline; changing the display of stacks of photos based on the change in the granularity of the timeline; receiving a second touch gesture through the touchscreen; in response to receiving the second touch gesture, translating the timeline; and changing the display of stacks of photos based on the translation of the timeline.

In some embodiments, either or both the first touch gesture and the second touch gesture comprise a single touch gesture on the touchscreen. In some embodiments, the single touch gesture may include at least one of a single upward drag of a finger of a user on the touchscreen; a single downward drag of a finger of a user on the touchscreen; a single rightward drag of a finger of a user on the touchscreen; and a single leftward drag of a finger of a user on the touchscreen. In some embodiments, the single touch gesture may include at least one of a single upward drag of a finger of a user on the touchscreen for a predetermined period of time; a single downward drag of a finger of a user on the touchscreen for a predetermined period of time; a single rightward drag of a finger of a user on the touchscreen for a predetermined period of time; and a single leftward drag of a finger of a user on the touchscreen for a predetermined period of time.

In some embodiments, the first touch gesture may include a single upward drag of a finger of a user on the touchscreen and the changing the granularity of the timeline comprises constricting the granularity of the timeline.

In some embodiments, the first touch gesture may include a single upward drag of a finger of a user on the touchscreen and the changing the granularity of the timeline comprises constricting the granularity of the timeline.

In some embodiments, the timeline may be arrayed along a first axis on the touchscreen and the first touch gesture includes a single upward drag of a finger of a user on the touchscreen in a direction substantially perpendicular with the first axis.

In some embodiments, the first touch gesture may include a drag of a finger of a user on the touchscreen along a first axis, and the second touch gesture includes a drag of a finger of a user on the touchscreen along a second axis, wherein the first axis and the second axis are substantially perpendicular.

Some embodiments include one or more non-transitory computer-readable media storing one or more programs that are configured, when executed, to cause one or more processors to execute the method or methods described within this document.

Some embodiments include a computing device including at least a touchscreen, a memory, and a processor. The touchscreen may be configured to display rendered media and translate interactions with a user into gesture signals. The memory may store data and/or processing instructions or software for the processor to execute. The processor may be communicatively coupled with the touchscreen and the memory. The processor may be configured to render a rendered display having a plurality of stacks of photos arranged with respect to a timeline, provide the rendered display to the touchscreen, and receive a first gesture signal from the touchscreen. In response to receiving the first gesture signal, the processor may be configured to change the granularity of the timeline in the first rendered display and provide the rendered display with the change in granularity to the touchscreen. The processor may be further configured to receive a second gesture signal from the touchscreen, and in response to receiving the second touch gesture, translate the timeline in the first rendered display and provide the rendered display with the translation in the timeline to the touchscreen.

In some embodiments, either or both the first gesture signal and the second touch gesture comprise a single gesture signal on the touchscreen.

In some embodiments, the single gesture signal comprises a single gesture signal selected from the list consisting of: a single upward drag of a finger of a user on the touchscreen; a single downward drag of a finger of a user on the touchscreen; a single rightward drag of a finger of a user on the touchscreen; and a single leftward drag of a finger of a user on the touchscreen.

In some embodiments, the single gesture signal comprises a single gesture signal selected from the list consisting of: a single upward drag of a finger of a user on the touchscreen for a predetermined period of time; a single downward drag of a finger of a user on the touchscreen for a predetermined period of time; a single rightward drag of a finger of a user on the touchscreen for a predetermined period of time; and a single leftward drag of a finger of a user on the touchscreen for a predetermined period of time.

In some embodiments, the first gesture signal comprises a single upward drag of a finger of a user on the touchscreen and the changing the granularity of the timeline comprises constricting the granularity of the timeline.

In some embodiments, the first gesture signal comprises a single upward drag of a finger of a user on the touchscreen and the changing the granularity of the timeline comprises constricting the granularity of the timeline.

In some embodiments, the timeline is arrayed along a first axis on the touchscreen and the first gesture signal includes a single upward drag of a finger of a user on the touchscreen in a direction substantially perpendicular with the first axis.

In some embodiments, the first gesture signal includes a drag of a finger of a user on the touchscreen along a first axis, and the second gesture signal includes a drag of a finger of a user on the touchscreen along a second axis, wherein the first axis and the second axis are substantially perpendicular.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates a mobile device that includes a touchscreen with some example gestures according to some embodiments.

FIG. 2 illustrates five columns of photo stacks organized horizontally across a display.

FIGS. 3A and 3B illustrate a change in the granularity of the timeline displayed in response to a gesture such as according to some embodiments.

FIGS. 4A and 4B illustrate a change in the granularity of the timeline displayed in response to a gesture such as according to some embodiments.

FIGS. 5A and 5B illustrate a translation in the timeline in response to a gesture according to some embodiments.

FIGS. 6A and 6B illustrate a translation in the timeline in response to a gesture according to some embodiments.

FIG. 7 illustrates stacks in a blended display in time according to some embodiments.

FIG. 8 illustrates an example flowchart of a process for displaying photo stacks according to some embodiments.

FIG. 9 shows an illustrative computational system for performing functionality to facilitate implementation of embodiments described herein.

### DETAILED DESCRIPTION

Embodiments of the invention include systems and methods for displaying a stack of photos on a display relative to a timeline. In some embodiments, the granularity of the timeline may be changed based on a single touch gesture from a user. In some embodiments, the timeline may be translated based on a single touch gesture from the user. While some embodiments are described in conjunction with a touchscreen and receiving touch gestures from a user through the touchscreen, embodiments include using a display without a touchscreen and receiving user interactions through a user interface such as, for example, a mouse or a keyboard.

Embodiments of the invention may solve problems associated with the display, presentation, organization, and/or manipulation of photos or videos on a user device such as, for example, a touchscreen device. Moreover, some embodiments simplify the display, presentation, organization, and/or manipulation of photos or videos on a user device. These problems did exist prior to the advent of such user devices. For example, the changes in granularity of a timeline and/or the translation of a timeline associated with a stack of photos using simple touch gestures were not known prior to the advent of touchscreen devices or touch input devices.

While some embodiments are described in conjunction with photos, various other data may be used in conjunction with or in addition to photos such as, for example, videos, icons, media, images, files, documents, etc.

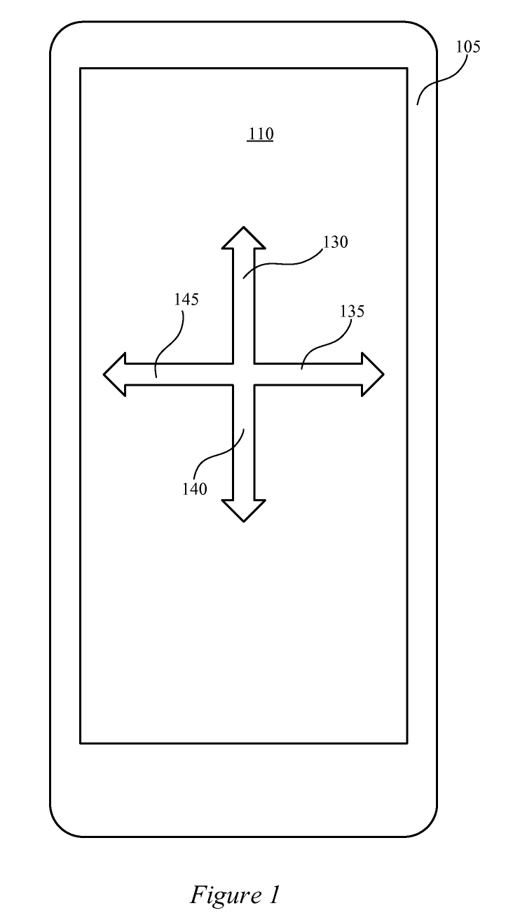

FIG. 1 illustrates a mobile device 105 that includes a touchscreen 110 (e.g., a touch-sensitive display). A user may manipulate display objects rendered and displayed on the touchscreen 110 using various gestures. These gestures may include, for example, an up gesture 130, a right gesture 135, a down gesture 140, and a left gesture 145. These gestures may be a single gesture performed by one or more appendages (e.g., finger) of the user and/or may include a single action of the user. In response to these gestures, the display objects may be manipulated. The mobile device 105 may be, for example, a smartphone or tablet.

In some embodiments, an event object may be created in response to a gesture of the user on the touchscreen 110. For example, a single touch by the user on the touchscreen 110 that drags a distance vertically upward on the touchscreen 110 and/or drags vertically upward on the touchscreen for a certain period of time may be interpreted as the up gesture 130. As another example, a single touch by the user on the touchscreen 110 that drags a distance vertically downward on the touchscreen 110 and/or drags vertically downward on the touchscreen for a certain period of time may be interpreted as the down gesture 140. As another example, a single touch by the user on the touchscreen 110 that drags a distance leftward (from the user's perspective) horizontally on the touchscreen 110 and/or drags leftward (from the user's perspective) horizontally on the touchscreen for a certain period of time may be interpreted as the left gesture 145. As another example, a single touch by the user on the touchscreen 110 that drags a distance rightward (from the user's perspective) horizontally on the touchscreen 110 and/or drags rightward (from the user's perspective) horizontally on the touchscreen for a certain period of time may be interpreted as the right gesture 135.

In some embodiments, different photo views may be presented on the touchscreen 110 based on the event object and/or the gesture.

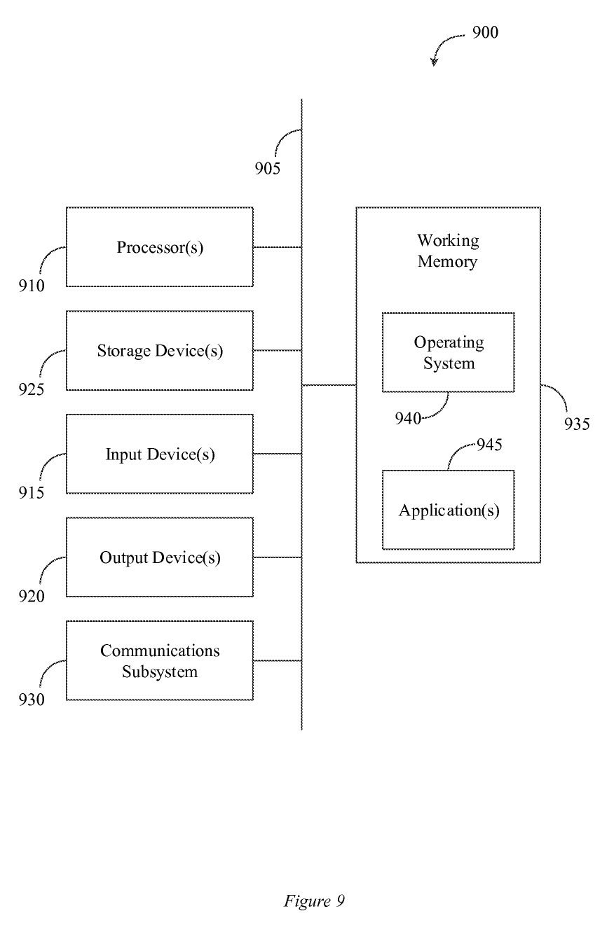

The mobile device 105 may include memory (e.g., working memory 935 and/or storage devices 925 shown in FIG. 9) that may store various photos, images, videos, etc., and/or metadata associated with the various photos, images, videos, etc.

The mobile device 105 may include a processor (e.g., processor 910 of FIG. 9) that may be configured to respond to gestures from a user and render the touchscreen 110 in response to the gestures.

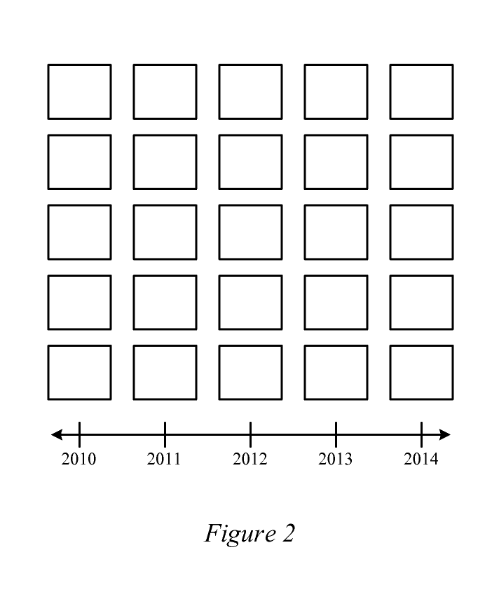

FIG. 2 illustrates five columns of photo stacks organized horizontally across a display. Each stack may include one or more photos. Each column includes five photo stacks organized vertically on a display that are created within a specific date range as specified in each photo's metadata. In FIG. 2, each column represents photos created in the years 2010, 2011, 2012, 2013, and 2014. Starting from the left, the first column of photo stacks includes all the photos stored in a memory location that were created in 2010. The second column of photo stacks includes all the photos stored in a memory location that were created in 2011. The third column of photo stacks includes all the photos stored in a memory location that were created in 2012. The fourth column of photo stacks includes all the photos stored in a memory location that were created in 2013. The fifth column of photo stacks includes all the photos stored in a memory location that were created in 2014. In FIG. 2 the time range when the photos were created spans five years from 2010 to 2014.

A photo stack may include one or more photos organized based on some parameter such as, for example, time, location, duration, faces, etc.

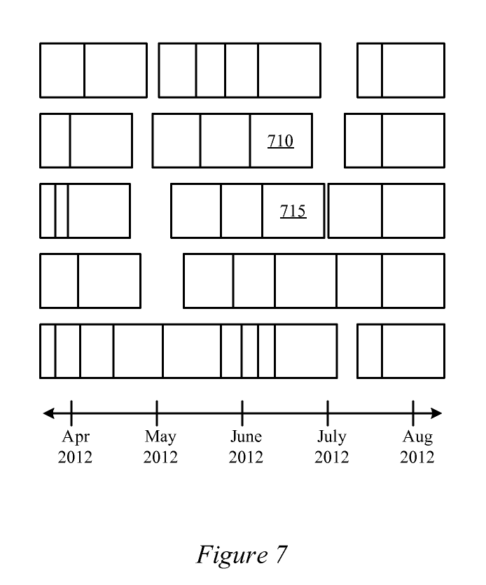

Each of the five photo stacks within each column of photos may be organized based on different time frames within the specific year. The number or granularity of the photos within each of the photo stacks may be organized any number of ways. For example, each stack may include a substantially equal fraction (e.g., one-fifth) of the photos created in the given year. As another example, each stack may represent photos taken within a specific time period (e.g., fractions of days, weeks, months, or years). Moreover, while FIG. 2 shows photos in columns, the photo stacks may be spread horizontally in time as shown in FIG. 7.

In some embodiments, each stack may represent multiple photos created during a given time frame. In some embodiments, the given time frame may vary depending on the granularity of the view. In some embodiments, each stack may represent photos created during a given day.

While FIG. 2 illustrates five columns of photo stacks, any number of columns may be displayed. Moreover, in some embodiments, any number of stacks may be displayed in each column. Furthermore, in some embodiments the photo stacks may be blended horizontally as shown in FIG. 7 and described below.

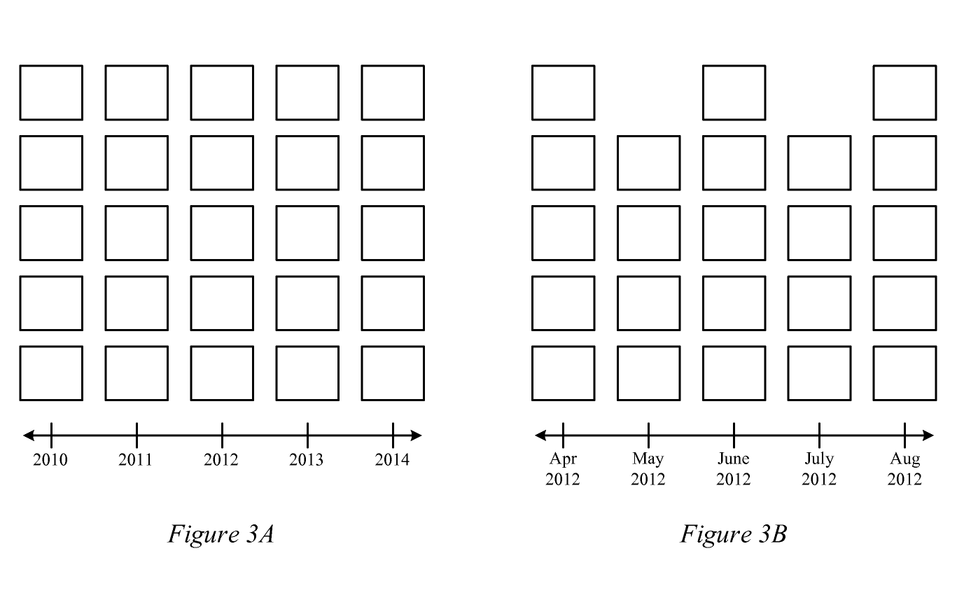

FIGS. 3A and 3B illustrate a change in the granularity of the timeline displayed in response to a gesture such as, for example, the up gesture 130 (or any other gesture). FIG. 3A illustrates the organization of photos and/or photo stacks as shown in FIG. 2. FIG. 3B illustrates a change in granularity along the horizontal axis (or x-axis) that may occur in response to a gesture. The photo stacks are now displayed as columns representing months in the year 2012.

Starting from the left, the first column of photo stacks includes all the photos stored in a memory location that were created in April 2012. The second column of photo stacks includes all the photos stored in a memory location that were created in May 2012. The third column of photo stacks includes all the photos stored in a memory location that were created in June 2012. The fourth column of photo stacks includes all the photos stored in a memory location that were created in July 2012. The fifth column of photo stacks includes all the photos stored in a memory location that were created in August 2012. In FIG. 3B the time range when the photos were created spans five months from April 2012 to August 2012.

The transition from the time range shown in FIG. 3A to the time range shown in FIG. 3B can occur in response to a gesture such as, for example, the up gesture 130 or the down gesture 140 (or any other gesture). For example, the granularity in time can change in response to a single touch gesture that may be made by a user using a single digit.

In some embodiments, depending on the granularity of the time scale and the photos stored in memory, there may not be enough photos to fill each stack as shown in FIG. 3B. In the example shown in FIG. 3B, the May 2012 and the July 2012 photo stacks do not include as many photos and are missing some photo stacks.

Alternatively or additionally, the granularity of the time scale may be changed from the time range shown in FIG. 3B to the time range shown in FIG. 3A in response to a different gesture such as, for example, the down gesture 140.

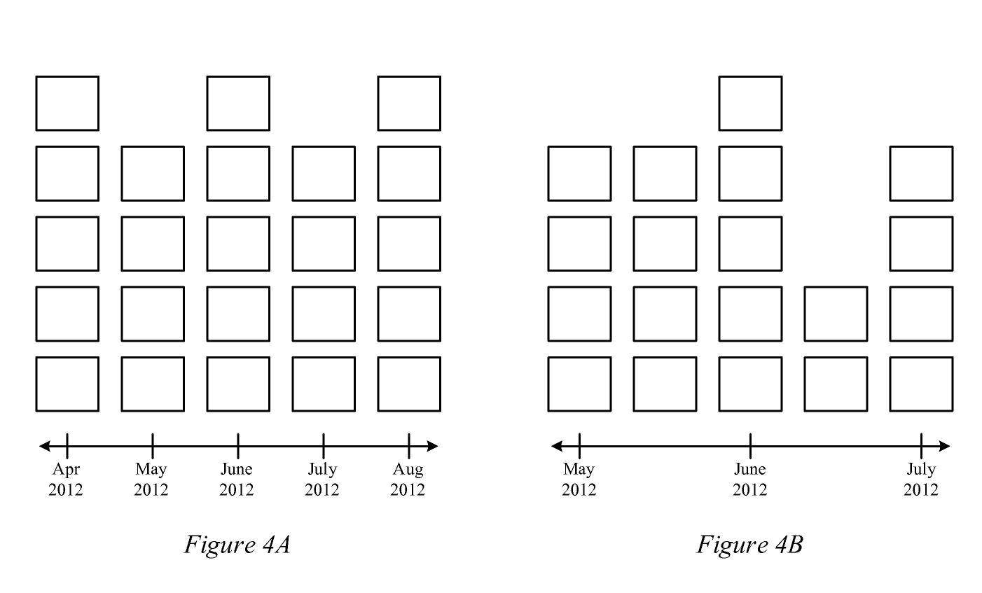

FIGS. 4A and 4B illustrate a change in the granularity of the timeline displayed in response to a gesture such as, for example, the up gesture 130 (or any other gesture described herein). As shown, the granularity of the time line changes from spanning six months in the year 2012 to spanning three months in the year 2012. As the granularity of the timeline changes, so does the number of stacks being displayed. Similarly, the granularity may be changed back from the granularity shown in FIG. 4B to the granularity shown in FIG. 4A in response to an opposite gesture such as, for example, the down gesture 140.

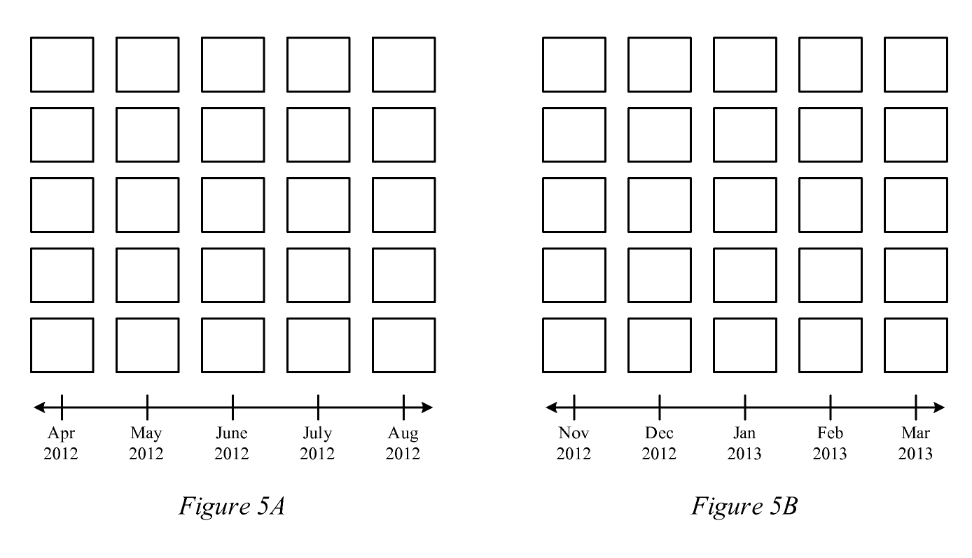

FIGS. 5A and 5B illustrate a translation in the timeline in response to a gesture such as, for example, the left gesture 145 (or the right gesture 135) or any other gesture. As shown, the translation shifts the months shown in the time line from the months of April-August 2012 to November 2012 to March 2013. As the timeline is changed, the displayed stacks are also changed to display stacks with photos created within the new timeline.

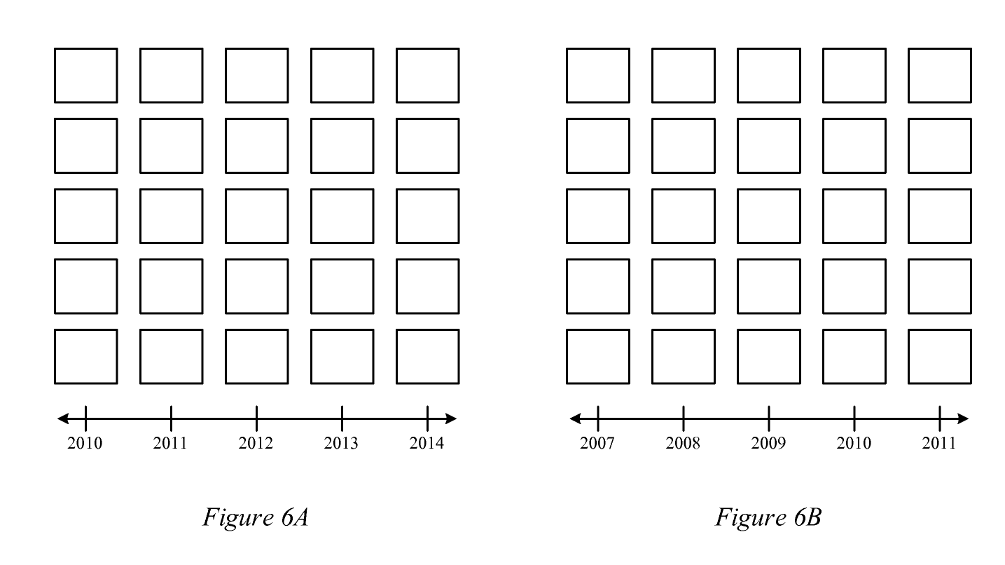

Alternatively or additionally, as shown in FIGS. 6A and 6B, the timeline may be translated regardless of the granularity of the timeline. As shown, the timeline is translated from the years 2010-1014 in FIG. 6A to the years 2007-2011 in FIG. 6B in response to a gesture.

In some embodiments, the up gesture 130 may be used to narrow the granularity of the timeline (e.g., finer granularity) or expand the timeline. The down gesture 140 may be used to broaden the granularity of the timeline (e.g., rougher granularity) or contract the timeline.

In some embodiments, the up gesture 130 may be used to broaden the granularity of the timeline (e.g., rougher granularity) or expand the timeline. The down gesture 140 may be used to narrow the granularity of the timeline (e.g., finer granularity) or contract the timeline.

In some embodiments, the right gesture 135 may be used to translate the timeline to later periods of time; and the left gesture 145 may be used to translate the timeline to earlier periods of time.

In some embodiments, the right gesture 135 may be used to translate the timeline to earlier periods of time; and the left gesture 145 may be used to translate the timeline to later periods of time.

In some embodiments, the timeline may be translated and/or the granularity may be changed using single touch gestures.

In some embodiments, angular gestures may be used to both translate the timeline and change the granularity of the timeline. For example, the granularity of the timeline may be narrowed and the timeline may be translated with an angular gesture in the upward and leftward directions. As another example, in response to a gesture upward and to the left, the timeline may be translated to earlier time periods (or later time periods) and the granularity may be narrowed (or broadened).

In some embodiments, the level of translation and/or narrowing may be proportional to the size, length, or time period associated with the gesture. For example, a long upward gesture may narrow the granularity of the timeline more than a short upward gesture. As another example, a short left gesture may move the timeline less than a long left gesture.

As shown in FIGS. 3A and 3B and FIGS. 4A and 4B, the granularity of the time scale displayed can be broadened in response to a given gesture and narrowed in response to an opposite gesture. Opposite gestures may be gestures that are made in opposite or substantially opposite directions on a touchscreen. For example, the up gesture 130 and the down gesture 140 are opposite gestures. As another example, the right gesture 135 and the left gesture 145 are opposite gestures. Various other gestures may be opposite gestures.

In some embodiments, the amount of granularity change in the timeline may be proportional with a feature of the gesture. For example, the level of granularity may be proportional with the amount of time the gesture is being made by the user and/or the distance across the touchscreen with which the gesture is made on the touchscreen 110. For example, the timeline may change from FIG. 2 to FIG. 4B in response to a gesture that occurs for a longer period of time and/or across a greater portion of the touchscreen than the gesture that changes the timeline from FIG. 2 to FIG. 3B.

Alternatively or additionally, the amount of translation in the timeline may be proportional with a feature of the gesture. For example, the amount of translation may be proportional with the amount of time the gesture is being made by the user and/or the distance across the touchscreen with which the gesture is made on the touchscreen 110.

As illustrated in FIG. 7, in some embodiments, each stack may represent photos created during a given day and each stack may then be displayed in a position along the horizontal axis depending on the date associated with the photos in the stack and the granularity of the time frame displayed. For example, the stacks may be placed in a continuum depending on the date associated with the respective stack. In some embodiments, the various stacks may be arranged vertically relative to one another to avoid overlapping. A first stack 710, associated with a first date and a second stack 715 associated with a second date that is close to the first date may be displayed near each other on the horizontal axis and/or displayed vertically offset.

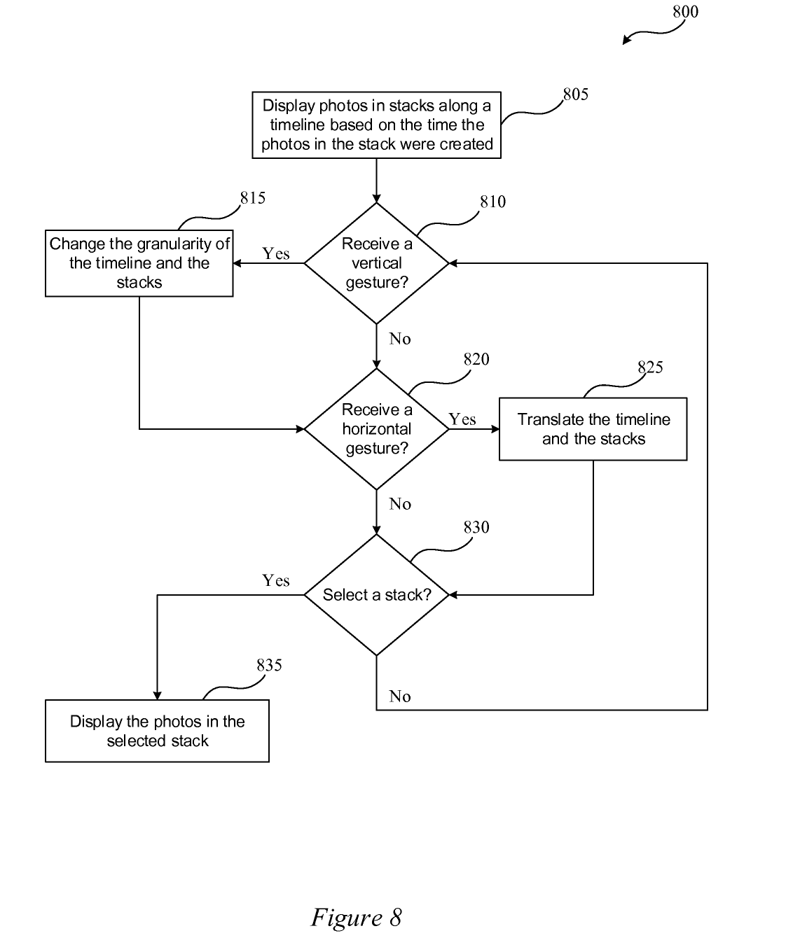

FIG. 8 illustrates an example flowchart of a process 800 for displaying photo stacks according to some embodiments. Although illustrated as discrete blocks, various blocks may be divided into additional blocks, combined into fewer blocks, or eliminated, depending on the desired implementation.

The process 800 starts at block 805 where photos are displayed in stacks on a display (e.g., the touchscreen 110) along a timeline based on the time the photos (and/or videos) in the stack were created. For example, at block 805 the stacks of photos may be displayed as shown in FIGS. 2, 3A, 3B, 4A, 4B, 5A, 5B, 6A, 6B, and/or 7. The photo stacks may be displayed in various other configurations, patterns, or ways.

The photos may be retrieved from a memory of the device and displayed and/or organized based on metadata associated with the photos and also stored in memory. In some embodiments, a processor (e.g., processor 910 of FIG. 9) may render a display of the photos along the timeline based on the metadata. The rendered display may then be displayed on a touchscreen or display. The processor, for example, may render the photos in stacks of one or more photos and/or may provide some photos as representative of the photos in the various stacks. The processor, for example, may be used to revise or adjust the organization of the photos in the stacks in response to various touch gestures provided by a user.

At block 810 it can be determined whether a vertical gesture has been received from the user through a user interface, for example, the touchscreen 110. The vertical gesture, for example, may include either the up gesture 130 or the down gesture 140. The vertical gesture may also be a single touch gesture. If it is determined that a vertical gesture has not been received from the user, then the process 800 proceeds to block 820. In some embodiments, a gesture other than the vertical gesture may be received at block 810.

If it is determined that a vertical gesture has been received from the user, then the process 800 proceeds to block 815 and the granularity of the timeline is changed. In some embodiments, the granularity of the timeline may be changed based on the magnitude and/or direction of the vertical gesture. For example, in response to the up gesture 130, the granularity of the timeline and the number of density of stacks of photos may be increased. As another example, in response to the down gesture 140, the granularity of the timeline and the number and/or density of the stacks of photos may be decreased.

The process 800 may then proceed to block 820. At block 820 it can be determined whether a horizontal gesture has been received from the user through a user interface, for example, the touchscreen 110. The horizontal gesture, for example, may include either the right gesture 135 or the left gesture 145. The horizontal gesture may also be a single touch gesture. If it is determined that a horizontal gesture has not been received from the user, then the process 800 proceeds to block 830.

If it is determined that a horizontal gesture has been received from the user, then the process 800 proceeds to block 825 and the timeline and the stacks of photos may be translated forward or backward in time. In some embodiments, the magnitude and/or direction of the translation of the timeline may be based on the magnitude and/or direction of the horizontal gesture. For example, in response to the right gesture 135, the timeline may be translated backwards in time. As another example, in response to the left gesture 145, the timeline may be translated forward in time.

The process 800 may then proceed to block 830. At block 830 it can be determined whether the user selects a stack of photos such as, for example, by touching a stack or tapping a stack through the touchscreen 110. If the user did select a stack, then the process 800 proceeds to block 835 where one or more photos in the stacks may be displayed. If the user did not select a stack, then the process 800 returns to block 810.

While blocks 810 and 820 are associated with vertical and horizontal gestures respectively, various other gestures may be used. In some embodiments, the different gestures used in these two blocks may be perpendicular to one another.

A computational system 900 (or processing unit) illustrated in FIG. 9 can be used to perform any of the embodiments of the invention. The mobile device 105, for example, may include one or more components of computational system 900. For example, the computational system 900 can be used alone or in conjunction with other components. As another example, the computational system 900 can be used to perform any calculation, solve any equation, perform any identification, and/or make any determination described above. The computational system 900 includes hardware elements that can be electrically coupled via a bus 905 (or may otherwise be in communication, as appropriate). The hardware elements can include one or more processors 910, including, without limitation, one or more general-purpose processors and/or one or more special-purpose processors (such as digital signal processing chips, graphics acceleration chips, and/or the like); one or more input devices 915 (e.g., which can include, without limitation, a mouse, a keyboard, and/or the like; and one or more output devices 920, which can include, without limitation, a display device, a printer, and/or the like.

The computational system 900 may further include (and/or be in communication with) one or more storage devices 925, which can include, without limitation, local and/or network-accessible storage and/or can include, without limitation, a disk drive, a drive array, an optical storage device, a solid-state storage device, such as random access memory (“RAM”) and/or read-only memory (“ROM”), which can be programmable, flash-updateable, and/or the like. The computational system 900 might also include a communications subsystem 930, which can include, without limitation, a modem, a network card (wireless or wired), an infrared communication device, a wireless communication device, and/or chipset (such as a Bluetooth® device, a 802.6 device, a Wi-Fi device, a WiMAX device, cellular communication facilities, etc.), and/or the like. The communications subsystem 930 may permit data to be exchanged with a network (such as the network described below, to name one example) and/or any other devices described herein. In many embodiments, the computational system 900 will further include a working memory 935, which can include a RAM or ROM device, as described above.

The computational system 900 also can include software elements, shown as being currently located within the working memory 935, including an operating system 940 and/or other code, such as one or more application programs 945, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 925 described above.

In some cases, the storage medium might be incorporated within the computational system 900 or in communication with the computational system 900. In other embodiments, the storage medium might be separate from the computational system 900 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 900 and/or might take the form of source and/or installable code, which, upon compilation and/or installation on the computational system 900 (e.g., using any of a variety of generally available compilers, installation programs, compression/decompression utilities, etc.), then takes the form of executable code.

The term “substantially” refers to a deviation less than about 10% of the value referred to. For example, a first line that is substantially perpendicular with a second line is a line that is perpendicular within a 10% deviation. For example, a first line that is substantially perpendicular with a second line is disposed at an angle that is 81° to 99° relative to the second line.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

That which is claimed:

1. A computing device comprising:
a touchscreen configured to display rendered media and translate interactions with a user into gesture signals;
a memory; and
a processor communicatively coupled with the touchscreen and the memory, the processor configured to:
render a rendered display having a plurality of stacks of photos arranged with respect to a timeline;
provide the rendered display to the touchscreen;
receive a first gesture signal from the touchscreen;
in response to receiving the first gesture signal, change a granularity of the timeline in the first rendered display;
provide the rendered display with the change in granularity to the touchscreen;
receive a second gesture signal from the touchscreen;
in response to receiving the second touch gesture signal, translate the timeline in the first rendered display; and
provide the rendered display with the translation in the timeline to the touchscreen.

2. The computing device according to claim 1, wherein either or both the first gesture signal and the second touch gesture signal comprise a single gesture signal on the touchscreen.

3. The method according to claim 2, wherein the single gesture signal comprises a single gesture signal selected from the list consisting of: a single upward drag of a finger of a user on the touchscreen; a single downward drag of a finger of a user on the touchscreen; a single rightward drag of a finger of a user on the touchscreen; and a single leftward drag of a finger of a user on the touchscreen.

4. The method according to claim 2, wherein the single gesture signal comprises a single gesture signal selected from the list consisting of: a single upward drag of a finger of a user on the touchscreen for a predetermined period of time; a single downward drag of a finger of a user on the touchscreen for a predetermined period of time; a single rightward drag of a finger of a user on the touchscreen for a predetermined period of time; and a single leftward drag of a finger of a user on the touchscreen for a predetermined period of time.

5. The computing device according to claim 1, wherein the first gesture signal comprises a single upward drag of a finger of a user on the touchscreen and the changing the granularity of the timeline comprises constricting the granularity of the timeline.

6. The computing device according to claim 1, wherein the timeline is arrayed along a first axis on the touchscreen and the first gesture signal includes a single upward drag of a finger of a user on the touchscreen in a direction substantially perpendicular with the first axis.

7. The computing device according to claim 1, wherein the first gesture signal includes a drag of a finger of a user on the touchscreen along a first axis, and the second gesture signal includes a drag of a finger of a user on the touchscreen along a second axis, wherein the first axis and the second axis are substantially perpendicular.

8. The computing device according to claim 1, wherein the stacks of photos may include one or more data elements selected from a group consisting of images, photographs, digital photos, videos, digital videos, documents, files, media, and icons.

9. A method comprising:
displaying a plurality of stacks of photos on a touchscreen of a user device with respect to a timeline;
receiving a first touch gesture through the touchscreen;
in response to receiving the first touch gesture, changing a granularity of the timeline;
changing the display of stacks of photos based on the change in the granularity of the timeline;
receiving a second touch gesture through the touchscreen;
in response to receiving the second touch gesture, translating the timeline; and
changing the display of stacks of photos based on the translation of the timeline.

10. The method according to claim 9, wherein either or both the first touch gesture and the second touch gesture comprise a single touch gesture on the touchscreen.

11. The method according to claim 10, wherein the single touch gesture comprises a single touch gesture selected from a list consisting of: a single upward drag of a finger of a user on the touchscreen; a single downward drag of a finger of a user on the touchscreen; a single rightward drag of a finger of a user on the touchscreen; and a single leftward drag of a finger of a user on the touchscreen.

12. The method according to claim 10, wherein the single touch gesture comprises a single touch gesture selected from a list consisting of: a single upward drag of a finger of a user on the touchscreen for a predetermined period of time; a single downward drag of a finger of a user on the touchscreen for a predetermined period of time; a single rightward drag of a finger of a user on the touchscreen for a predetermined period of time; and a single leftward drag of a finger of a user on the touchscreen for a predetermined period of time.

13. The method according to claim 9, wherein the first touch gesture comprises a single upward drag of a finger of a user on the touchscreen and the changing the granularity of the timeline comprises constricting the granularity of the timeline.

14. The method according to claim 9, wherein the timeline is arrayed along a first axis on the touchscreen and the first touch gesture includes a single upward drag of a finger of a user on the touchscreen in a direction substantially perpendicular with the first axis.

15. One or more non-transitory computer-readable media storing one or more programs that are configured, when executed, to cause one or more processors to execute the method as recited in claim 9.
